(19) United States
(12) Patent Application Publication
(10) Pub. No.: US 2004/0003166 A1
(43) Pub. Date: Jan. 1, 2004

(54) Portable electronic medium issuing system and issuing method and portable electronic medium

(76) Inventor: Satoshi Sekiya, Yokohama-shi (JP)

Correspondence Address: PILLSBURY WINTHROP, LLP, P.O. BOX 10500, MCLEAN, VA, 22102, US

(21) Appl. No.: 10/242,792

(22) Filed: Sep. 13, 2002

(30) Foreign Application Priority Data
Jun. 28, 2002 (JP) 2002-190887

(51) Int. Cl. G06F 12/00

(52) U.S. Cl. 711/103

(57) ABSTRACT

This invention executes a series of instructions to issue an IC card on a computer side which issues an IC card, previously simulates a change in the contents written into a nonvolatile memory of the IC card, and transfers the written contents to the IC card to write the same into the nonvolatile memory.

### CROSS-REFERENCE TO RELATED APPLICATIONS

This application is based upon and claims the benefit of priority from the prior Japanese Patent Application No. 2002-190887, filed Jun. 28, 2002, the entire contents of which are incorporated herein by reference.

### BACKGROUND OF THE INVENTION

1. Field of the Invention

This invention relates to the technique for attaining high performance and increasing the number of functions of a portable electronic medium which is generally called an IC card.

2. Description of the Related Art

An IC card is set into a serviceable state by defining necessary key files, data files and the like in a nonvolatile memory provided inside the IC card according to the service objectives and applications and writing data into the above files.

The above process is generally called “issuance”.

In the IC card, a function which executes instructions to issue the IC card itself is prepared, and generally, one file can be defined or data of one unit can be written by executing one instruction.

Issuance of the IC card is made by sequentially executing instructions of a number corresponding to the number of necessary files and data items.

Therefore, when an IC card is issued, instructions used to define files and instructions used to write data as described before are adequately combined and executed, and thus, definition information and data are written in the nonvolatile memory in the IC card each time the instruction is executed.

However, in the above instructions, a large amount of information items such as instruction codes and transmission control information required for communication are contained in addition to information written in the nonvolatile memory.

As a result, information which is redundant in comparison with information to be really written into the nonvolatile memory is transmitted to the card.

Further, generally, the IC card receives each external instruction via a relatively low speed serial interface or sends a response for each instruction.

The speed is generally only 9600 bits/sec in a normal contact type IC card.

Therefore, in the issuing process for transmitting/receiving redundant data as described above, the time required for the transmission process becomes extremely long.

Next, the instruction executing procedure with respect to an IC card in the conventional IC card issuing process is explained.

That is, instructions which define key files and data files in the nonvolatile memory in the IC card and instructions used to write data into the above files are sequentially executed in a predetermined order.

Each instruction is configured by a combination of an instruction code, attached information (such as definition information of the file and data itself to be written) and protocol control information used to perform serial communication.

Further, each time execution of one instruction is terminated, a response code indicating the result of execution is output from the IC card together with the protocol control information.

Thus, conventionally, there occurs a problem that an extremely long time is required for the communication process, and the time required for issuing an IC card becomes long since a large number of redundant instructions are sent to the card via the low-speed interface in the IC card issuing process.

### BRIEF SUMMARY OF THE INVENTION

An object of this invention is to provide a portable electronic medium and a portable electronic medium issuing system and issuing method in which a host device and a portable electronic medium are coupled by serial communication and which can shorten the time for transmission of a message from the host device and reduce the time for the issuing process by storing data received according to the message in a nonvolatile memory when a portable electronic medium is issued.

A portable electronic medium of this invention in which application data is stored in a nonvolatile memory based on a plurality of instructions supplied from an external device by serial communication and which performs processes by use of the stored application comprises storage means for previously storing application data which is obtained by simulation based on a plurality of instructions, and which is to be stored in the nonvolatile memory, in the nonvolatile memory by use of the external device.

In a portable electronic medium issuing system of this invention in which a host device and a portable electronic medium are coupled by serial communication and which includes a nonvolatile memory used to store files and file control information, the host device includes first creation means for creating a plurality of instruction messages for issuance of a portable electronic medium, second creation means for creating files and file control information which are obtained by simulation based on a plurality of instruction messages created by the first creation means and stored in a nonvolatile memory, and first transmission means for transmitting the files and file control information created by the second creation means and stored in the nonvolatile memory to the portable electronic medium by use of one message; and the portable electronic medium has storage means for storing files and file control information obtained by simulation based on a plurality of instructions supplied from the host device, and stored in the nonvolatile memory, in the nonvolatile memory.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate presently preferred embodiments of the invention, and together with the general description given above and the detailed description of the preferred embodiments given below, serve to explain the principles of the invention.

FIG. 1 is a block diagram schematically showing an example of the configuration of an IC card issuing system according to one embodiment of this invention,

FIG. 2 is a block diagram schematically showing an example of the configuration of an IC card,

FIG. 3 is a diagram showing one example of a file structure in a data memory of the IC card,

FIG. 4 is a flowchart for illustrating the card issuing process,

FIG. 5 is a flowchart for illustrating the card issuing process,

FIG. 6 is a diagram for illustrating a process from creation of a message to reception of a response message,

FIGS. 7A to 7E are diagrams showing examples of messages,

FIG. 8 is a diagram showing one example of a file structure in a data memory of the IC card,

FIG. 9 is a flowchart for illustrating a card issuing process,

FIG. 10 is a flowchart for illustrating a card issuing process,

FIG. 11 is a diagram for illustrating a process from creation of a message to reception of a response message,

FIG. 12 is a flowchart for illustrating a card issuing process,

FIG. 13 is a flowchart for illustrating a card issuing process, and

FIG. 14 is a diagram for illustrating a process from creation of a message to reception of a response message.

### DETAILED DESCRIPTION OF THE INVENTION

(First Embodiment)

There will now be described an IC card issuing system as an IC card processing system of this invention with reference to the accompanying drawings.

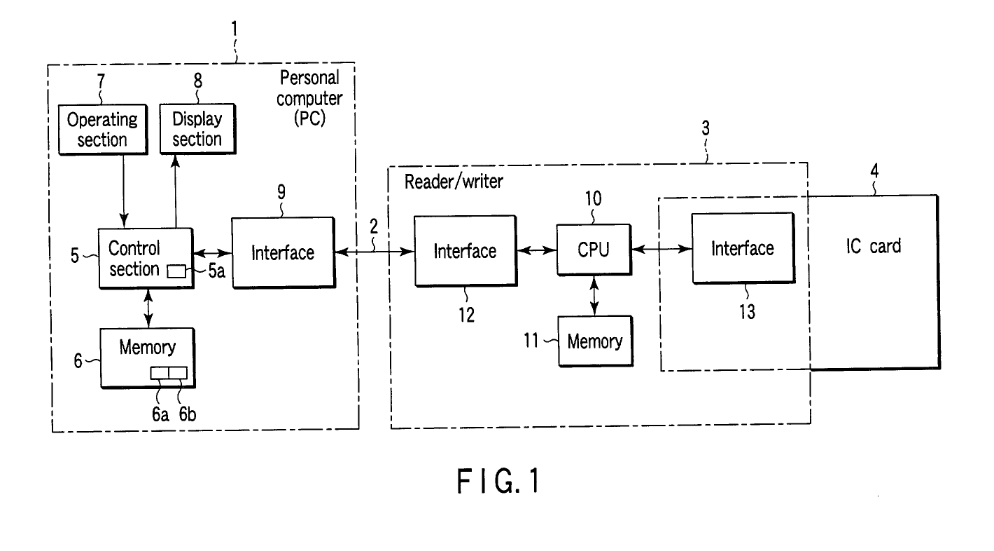

As shown in FIG. 1, an IC card issuing system includes a personal computer (PC) 1 as a host device and a reader/writer 3 connected to the PC 1 via a communication line 2. An IC card 4 as a to-be-issued card connected via a connector (not shown) is to be mounted in the reader/writer 4.

The PC 1 includes a control section 5 which controls the whole portion of the PC 1, a memory 6 in which a control program is stored and various data items are to be stored, an operating section 7 such as a keyboard used to issue operation instructions, a display section 8 which displays operation guidance and the like, and an interface 9 which transfers data with respect to the reader/writer 3.

The control section 5 has the function of authenticating a master key stored in the memory 6 as a secret key with respect to a manufacturer's serial number (card inherent information) supplied from the IC card 4.

The control section 5 includes an internal memory 5a which has the same storage structure as the data memory 17 used as an EEPROM of the IC card 4 which will be described later and is of 8k-byte configuration, for example.

In the memory 6 are a program 6a which creates issuing messages to be sequentially transmitted to the IC cards 4 of respective card types to be issued and a program 6b which simulates a function equivalent to that of a to-be-issued IC card which stores data in the data memory 17 based on the thus created issuing messages.

The issuing message includes transmission data, command code and protocol control information necessary for serial communication, and a head code and end code are attached thereto. As the command codes, there are provided C1: definition of a key file, C2: writing of key data, C3: definition of a data file, C4: writing of data, and Cz: writing of data into the data memory 17.

The control section 5 stores real data which is expanded as bitmap data and written in the data memory 17 into the internal memory 5a based on the issuing message and the program used to run the above simulation.

The control section 5 creates an issuing data lumping message by using the real data stored in the internal memory 5a as issuing data and transmits the same to the IC card 4 via the reader/writer 3.

The reader/writer 3 includes a CPU 10 which controls the whole portion of the reader/writer 3, a memory 11 in which a control program is stored and various data items are to be stored, an interface 12 which transfers data with respect to the PC 1, and an interface 13 which transfers data with respect to the IC card 4. Further, the reader/writer 3 has a detector (not shown) which detects insertion of the IC card 4 and outputs the detection result to the PC 1. Further, the reader/writer 3 may be designed to read the contents of the IC card 4 when insertion of the IC card 4 is detected and output to the PC 1 data indicating whether or not the card is an issuing card in which an application and the like are not yet recorded.

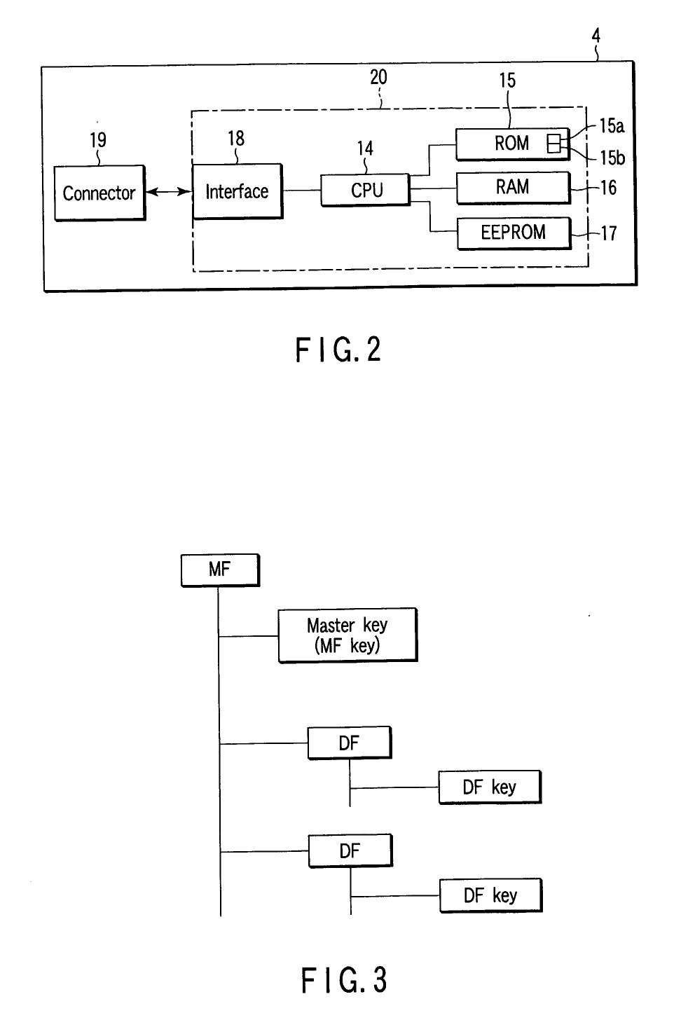

As shown in FIG. 2, the IC card 4 includes a CPU (control element) 14 which controls the whole portion of the IC card 4, a ROM (program memory) 15 in which a control program for the internal operation of the card is stored, a RAM (working memory, volatile memory) 16 used as a transmission/reception buffer of messages which are to be exchanged with respect to the exterior (reader/writer 3) and a temporary storage buffer for data which is being processed by the CPU 14, a data memory (nonvolatile memory) 17 configured by an EEPROM in which operation data used by reading/writing the contents thereof according to an application is stored and a manufacturer's serial number or the like inherent to the card as message concealing key data (realized by also using a master key which will be described later) is stored, an interface 18 which transfers data with respect to the reader/writer 3, and a contact portion 19.

The IC card 4 receives an instruction from the exterior via a relatively low speed serial interface or sends a response with respect to the instruction, and the speed thereof is generally 9600 bits/sec in a normal contact type IC card.

The CPU 14, ROM 15, RAM 16, data memory 17, interface 18 are configured by an IC chip 20, and the contact portion 19 and IC chip 20 are integrally formed in a module and embedded in the main body of the IC card.

In the ROM 15, a command search table 15a in which CLA, INS and the like are registered is provided. In the command search table 15a, the types of command messages based on the command codes are registered.

When receiving a command message, the CPU 14 searches the command search table 15a to determine the type of the command message based on a command code attached to the head of a command header.

In the RAM 16, an access condition flag indicating that an access right is set up is provided and is set by collation or authentication of a key.

FIG. 3 shows one example of a file structure in the data memory 17.

FIG. 3 shows the file structure in the data memory 17 of the IC card 4 and the main folder (MF) is set at the center, a master key (MF key) for issuance and a plurality of data folders (DF) are branched from the main folder (MF) and DF keys are branched from the respective data folders (DF).

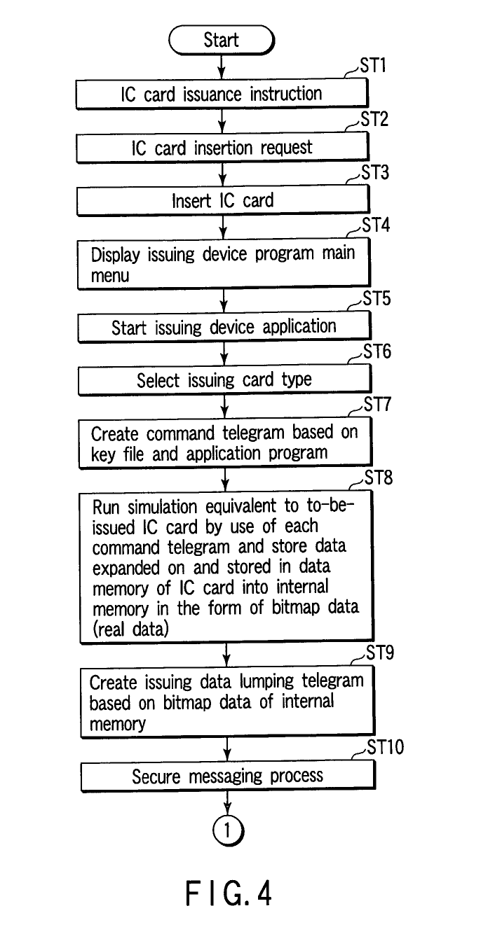

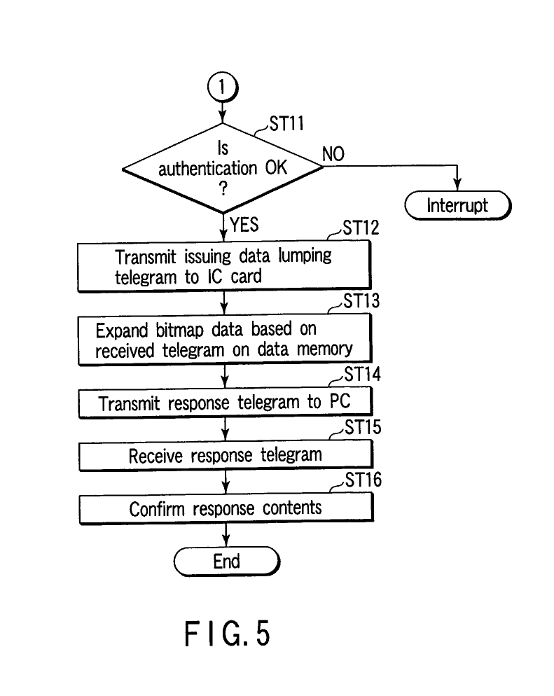

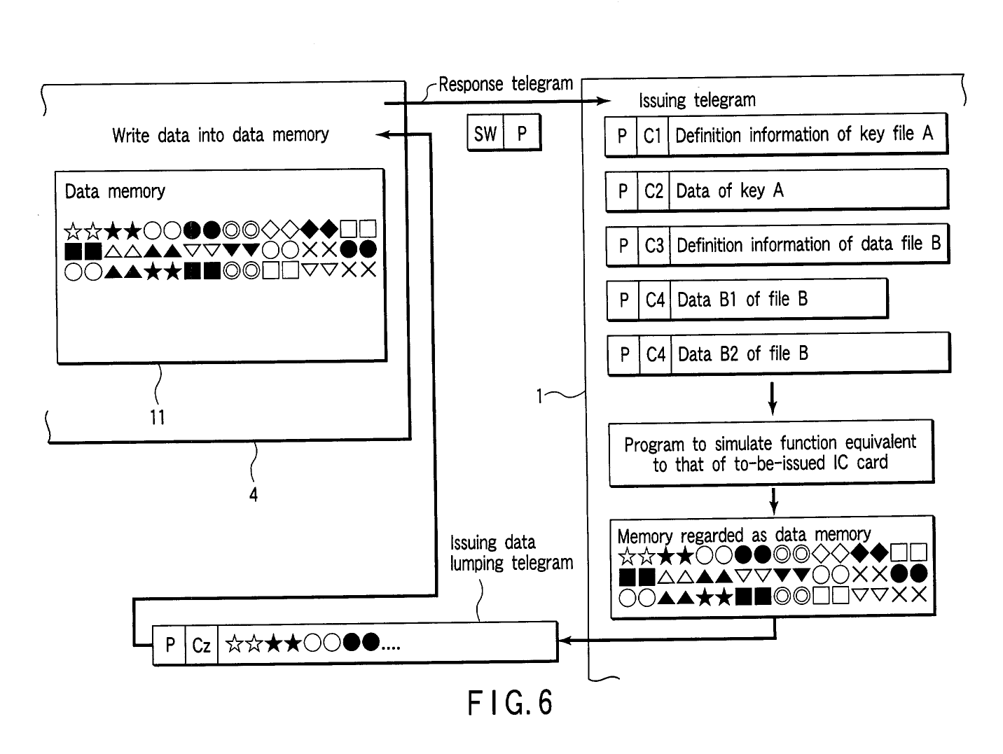

Next, one example of the issuing process of the IC card 4 is explained with reference to the flowcharts shown in FIGS. 4, 5 and the flow of the process shown in FIG. 6.

In this example, as individual data of the IC card 4, a manufacturer's serial number stored in the data memory 17 when the IC chip is manufactured is used. Further, a master key registered in the hardware module at the time of formation of the IC chip is used.

First, an issuing device icon on the screen of the display section 8 of the PC 1 is clicked (ST1). Then, the control section 5 determines issuance of an IC card and causes the display section 8 to display a request to insert an issuing IC card 4 into the reader/writer 3 (ST2).

Based on the display contents, an IC card 4 to be issued is inserted into the reader/writer 3 (ST3).

Then, the control section 5 causes the display section 8 to display an issuing device program main menu (ST4) based on an insertion detecting signal (output from the reader/writer 3 to the control section 5 of the PC 1) and starts an issuing device application (ST5). The type of an issuing card is selected by use of the operating section 7 based on the menu display contents (ST6).

Thus, the control section 5 creates lines of issuing messages to be transmitted to the IC card 4 based on selection of the type of issuing card (ST7).

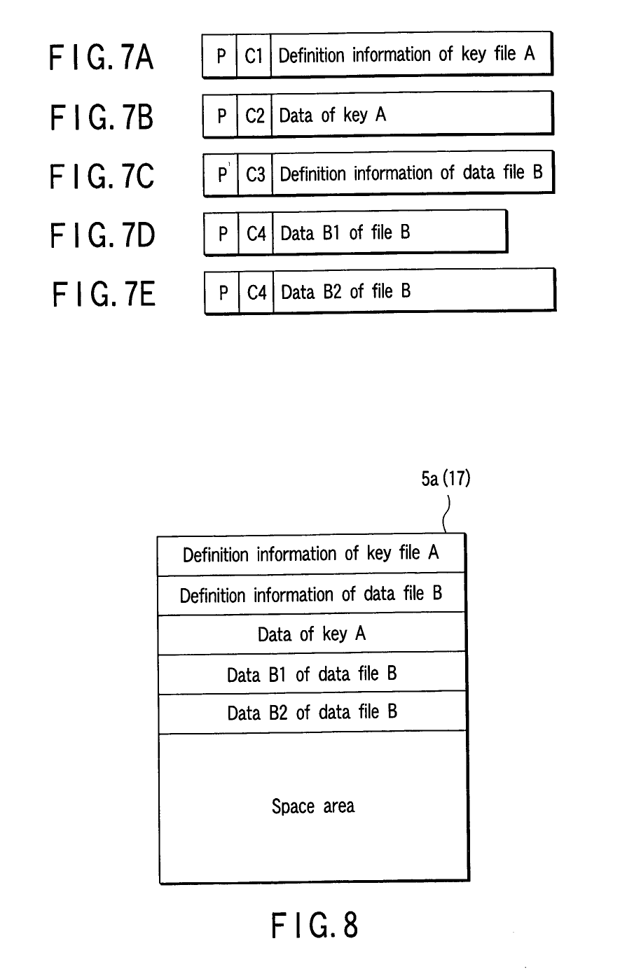

For example, a first message in which protocol control information P and a command C1 indicating the definition of a key file A are attached to definition information of the key file A as shown in FIG. 7A, a second message in which protocol control information P and a command C2 indicating writing of data of the key A are attached to the data of the key A as shown in FIG. 7B, a third message in which protocol control information P and a command C3 indicating the definition of a data file B are attached to definition information of the data file (application program) B as shown in FIG. 7C, a fourth message in which protocol control information P and a command C4 indicating writing of data B1 of the data file B are attached to the data B1 of the data file B as shown in FIG. 7D, and a fifth message in which protocol control information P and a command C5 indicating the data B1 of the data file B are attached to data B2 of the data file B as shown in FIG. 7E are created.

The data B1 of the data file B is common data irrespective of the types and applications of the IC cards 4 and the data B2 of the data file B is data such as individual information which is different for each IC card 4.

Further, the control section 5 reads out a program which simulates a function equivalent to that of a to-be-issued IC card 4 from the memory 6 and expands and stores data (bitmap data) which is the same as data expanded on and stored in the data memory 17 of the IC card 4 according to the created issuing messages based on the above program on and in the internal memory 5a (ST8). That is, as shown in FIG. 8, the definition information of the key file A, the definition information of the data file B, data of the key A, data B1 of the data file B and data B2 of the data file B are stored.

Further, the control section 5 creates a issuing data lumping message by use of bitmap data of the internal memory 5a (ST9). As shown in FIG. 6, the issuing data lumping message is configured by attaching protocol control information P and a command Cz indicating writing into the data memory 17 to the bitmap data.

Next, the control section 5 performs a secure messaging process as an authentication process of the IC card 4 by use of the MF key (ST10).

As a result, when the IC card 4 is authenticated (ST11), the control section 5 transmits the issuing data lumping message to the CPU 14 of the IC card 4 (ST12).

Further, the CPU 14 of the IC card 4 writes issuing data based on bit map data of the received issuing data lumping message into the data memory 17 (ST13).

The CPU 14 of the IC card 4 outputs a response message (which includes a response code SW and protocol control information P) as the result of the writing process to the control section 5 of the PC 1 (ST14).

As a result, the control section 5 of the PC 1 receives the response message as the processing result from the IC card 4 (ST15) and confirms the response contents (ST16).

Further, if authentication of the IC card 4 is not successfully made (ST11), the issuing process is interrupted.

As described above, in a system in which the IC card issuing device and the IC card are coupled by serial communication and which issues the IC card by storing data received according to a message from the IC card issuing device into the nonvolatile memory, the message transmission time can be reduced (from several minutes to several tens of seconds) and the issuance processing time can be reduced.

(Second Embodiment)

Further, in the first embodiment, a case where the contents of the nonvolatile memory obtained after all of the data items containing individual information and the like are written are simulated is explained, but this invention is not limited to this case. For example, individual information and the like can be written by use of the conventional write instruction.

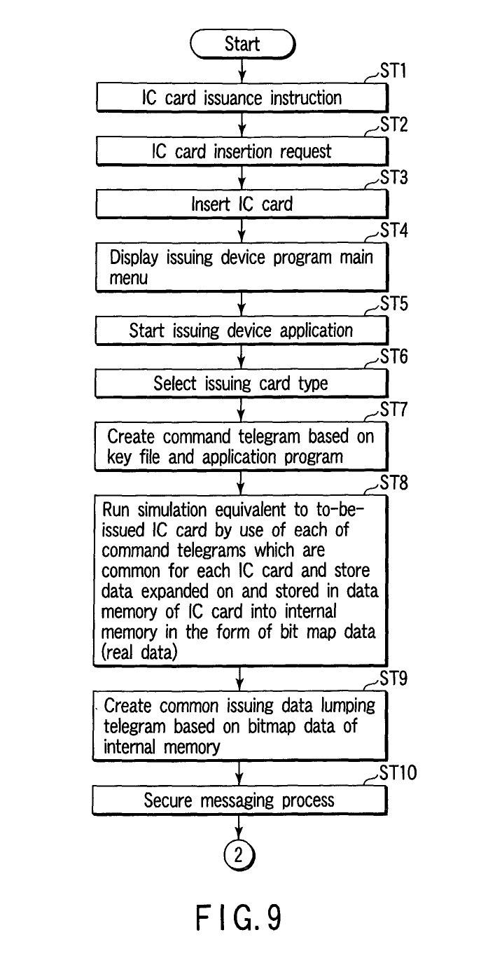

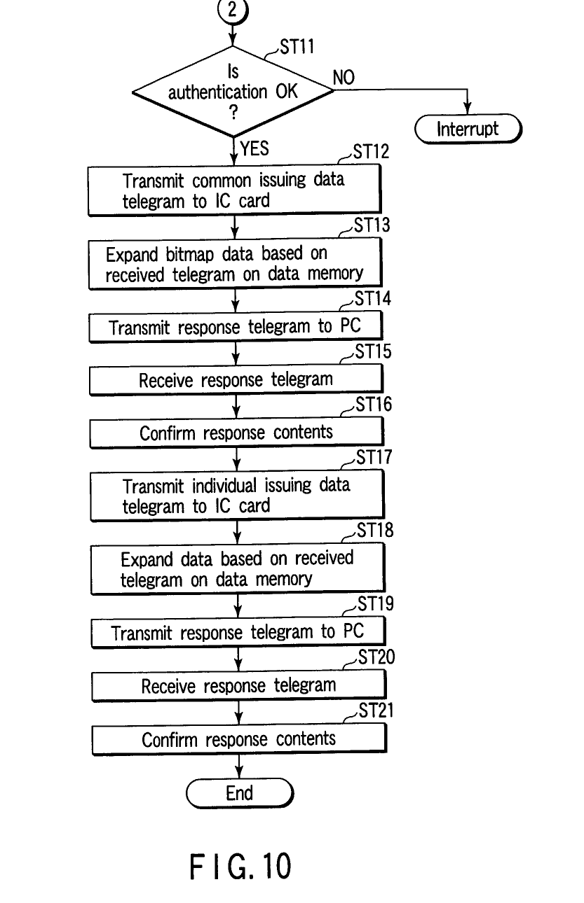

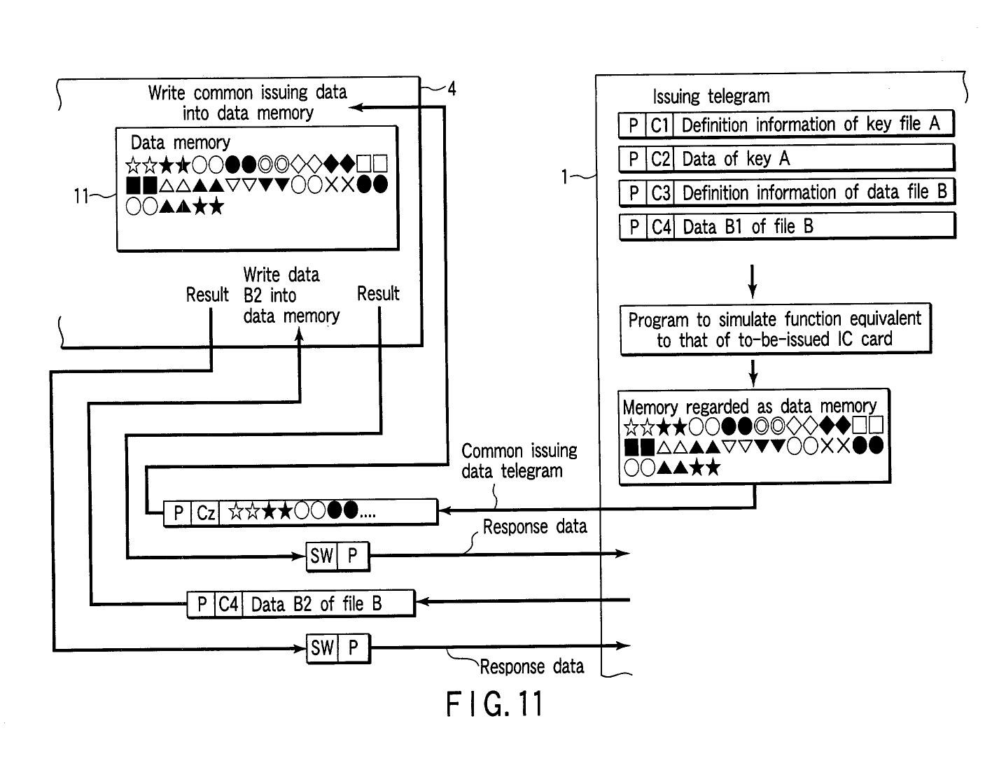

The operation performed in this case is explained with reference to the flowcharts shown in FIGS. 9, 10 and the flow of a process shown in FIG. 11. In FIGS. 9, 10, 11, portions which are the same as those in the flowcharts shown in FIGS. 4, 5 and the flow of the process shown in FIG. 6 are denoted by the same symbols and the explanation thereof is omitted.

That is, after a command message is created in step ST7, the control section 5 reads out a program which is used to simulate the function equivalent to that of a to-be-issued IC card 4 from the memory 6. Then, the control section 5 expands and stores data (bit map data) which is the same as data expanded on and stored in the data memory 17 of the IC card 4 according to a message which is common to the IC cards in the created issuing message based on the above program on and into the internal memory 5a (ST8′). That is, definition information of the key file A, definition information of the data file B, data of the key A and data B1 of the data file B are stored.

Further, the control section 5 creates a common issuing data message based on the bitmap data in the internal memory 5a (ST9′). As shown in FIG. 11, in the common issuing data message, protocol control information P and a command Cz indicating writing into the data memory 17 are attached to the bitmap data.

Next, the control section 5 performs a secure messaging process as the authentication process of the IC card 4 by use of the MF key (ST10).

Thus, when the authentication process for the IC card 4 is successfully performed (ST11), the control section 5 transmits the common issuing data message to the CPU 14 of the IC card 4 (ST12′).

Then, the CPU 14 of the IC card 4 writes issuing data based on the bitmap data of the received common issuing data message into the data memory 17 (ST13′).

The CPU 14 of the IC card 4 outputs a response message (including a response code SW and protocol control information P) obtained as the result of the writing process to the control section 5 of the PC 1 (ST14).

Thus, the control section 5 of the PC 1 receives the response message from the IC card 4 as the result of the process (ST15) and confirms the response contents thereof (ST16).

After the confirmation, the control section 5 of the PC 1 transmits “data B2 of the data file B” as an individual issuing data message to the IC card (ST17).

Then, the CPU 14 of the IC card 4 additionally expands data which is based on the received individual issuing data message on the data memory 17 (ST18).

The CPU 14 of the IC card 4 outputs a response message (including a response code SW and protocol control information P) obtained as the result of the writing process to the control section 5 of the PC 1 (ST19).

Thus, the control section 5 of the PC 1 receives the response message from the IC card 4 as the result of the process (ST20) and confirms the response contents thereof (ST21).

As described above, part of an instruction group obtained by excluding part of issuing instructions such as an instruction of writing data or individual information which is different for each IC card to be issued is processed based on the above procedure. Then, the issuing process for the remaining part of the instructions is performed by use of the conventional instructions later.

As a result, it becomes unnecessary to run a simulation for each IC card on the computer side by processing only the instructions which are common to all of the IC cards according to the above procedure and the process on the computer side can be simplified.

(Third Embodiment)

In the first embodiment, data transmitted in the form of an issuing data lumping message is data stored in the internal memory 5a, but it is possible to compress data of the writing contents into the nonvolatile memory by use of the data compression technique so as to further reduce the transmission time. At this time, it is necessary to decompress the compressed issuing data lumping message on the IC card side.

In this case, a program to decompress compressed data transmitted to the IC card 4 is not provided on the program memory (ROM 15) and the program is written into a working memory (RAM 16) of the IC card 4 from the exterior at the start time of the issuing process.

Thus, the decompression program which is used only at the issuing time of an IC card is not stored in the program memory (ROM 15) so that the limited program memory area can be effectively used.

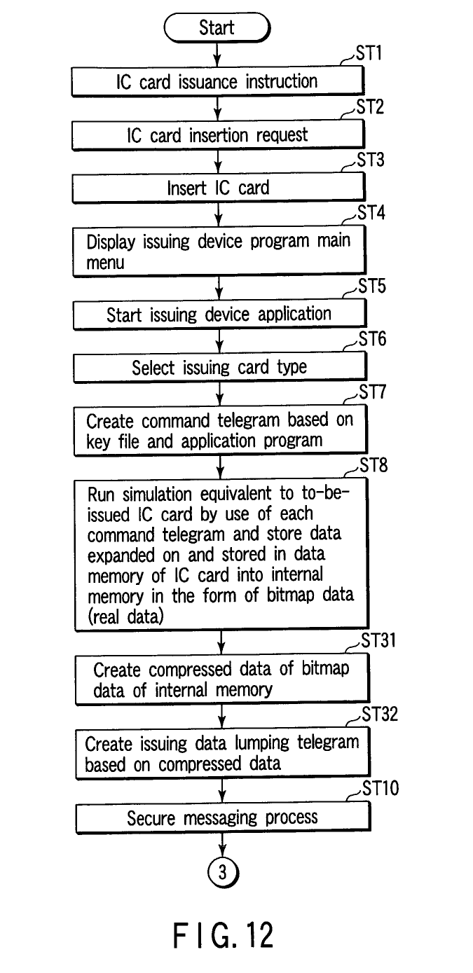

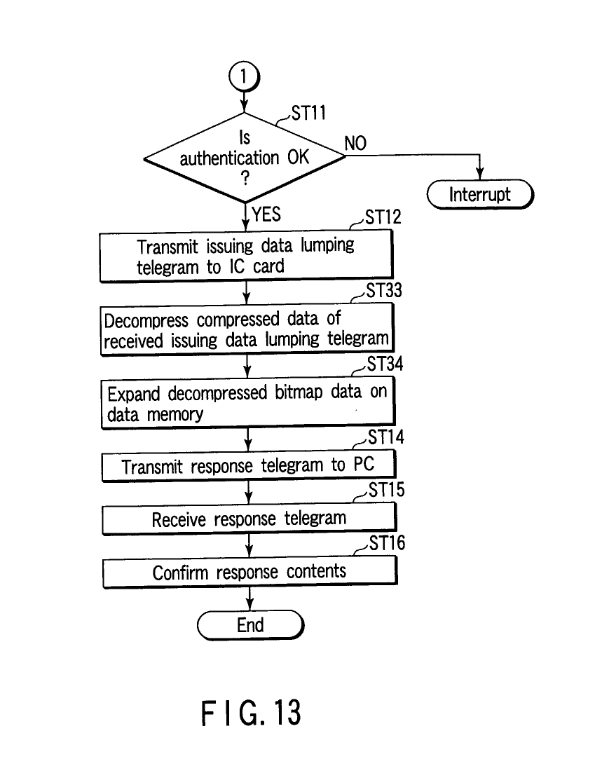

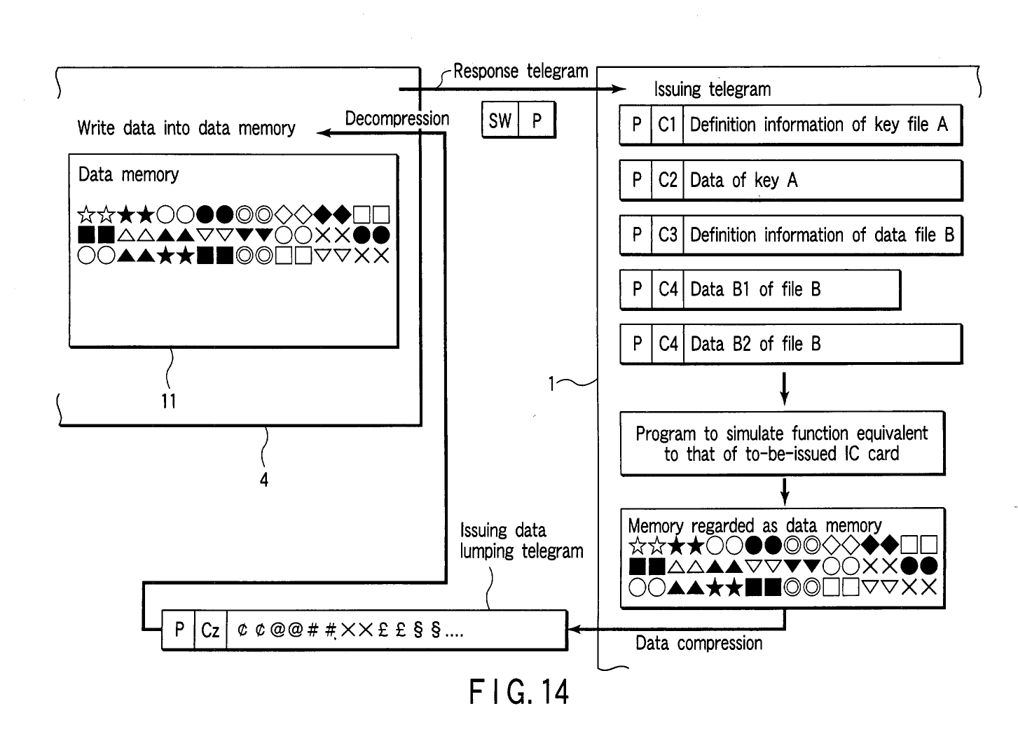

The operation performed in this case is explained with reference to the flowcharts shown in FIGS. 12, 13 and the flow of a process shown in FIG. 14. In FIGS. 12, 13, 14, portions which are the same as those in the flowcharts shown in FIGS. 4, 5 and the flow of the process shown in FIG. 6 are denoted by the same symbols and the explanation thereof is omitted.

That is, the control section 5 creates compressed data (ST31) with respect to bitmap data (real data) stored in the internal memory in the step ST8 and creates an issuing data lumping message based on the compressed data (ST32). As shown in FIG. 14, the issuing data lumping message has protocol control information P and a command Cz indicating writing into the data memory 17 attached to the compressed data of the bitmap data.

Next, the control section 5 performs a secure messaging process as the authentication process of the IC card 4 by use of the MF key (ST10).

Thus, when the authentication process for the IC card 4 is successfully performed (ST11), the control section 5 transmits the issuing data lumping message to the CPU 14 of the IC card 4 (ST12).

Then, the CPU 14 of the IC card 4 decompresses the compressed data of the received issuing data lumping message into bitmap data by use of a program to decompress the compressed data of the RAM 16 (ST33) and writes issuing data based on the decompressed bitmap data into the data memory 17 (ST34).

The CPU 14 of the IC card 4 outputs a response message (including a response code SW and protocol control information P) obtained as the result of the writing process to the control section 5 of the PC 1 (ST14).

Thus, the control section 5 of the PC 1 receives the response message from the IC card 4 as the result of the process (ST15) and confirms the response contents thereof (ST16).

As described above, when a series of instructions (instruction execution procedure) executed at the time of issuance of an IC card is executed, the type of information which is to be set in the nonvolatile memory of the IC card is previously simulated on the issuing computer side. Then, the contents thereof are transmitted to the IC card and written into the nonvolatile memory of the IC card so that an IC card can be issued with less communication in comparison with conventional issuing procedure in which a large number of instructions are combined and transmitted to the card.

Thus, since the simulation process is performed in the memory in the computer, the result can be attained at extremely high speed. The contents obtained as the result and written into the nonvolatile memory are transmitted to the IC card by use of a special instruction and written into the nonvolatile memory of the IC card as they are.

As a result, it becomes possible to reduce time required for the communication process and drastically reduce the processing time of the whole issuing process.

Further, data written into the IC card when issuing the IC card contains two types of data items including common data for respective types and application of IC cards and data items such as individual information items which are different for respective cards.

As the method for issuing an IC card, the procedure for simulating the contents of the nonvolatile memory after all data including individual information has been written and the procedure for separately writing individual information by use of the conventional writing instructions can be selectively used.

Further, when the contents of the nonvolatile memory are transferred to the IC card, the procedure for transferring the data to the IC card after the data size thereof is compressed by use of the data compression technique, decompressing the compressed data in the IC card and writing the decompressed data into the nonvolatile memory can be selected.

When the above writing procedure is performed, a method for executing a program for decompression stored in the program memory (ROM) of the IC card or a method for executing the program which is written into a working memory (RAM) before transferring can be selectively used.

That is, after a series of instructions for issuance of an IC card is executed with respect to the IC card on the computer side which issues the IC card, a change in the contents written into the nonvolatile memory of the IC card is previously simulated and the written contents are transferred to the IC card and written into the nonvolatile memory.

As a result, the amount of communication with respect to the IC card is reduced in the IC card issuing process, and consequently, time required for issuance of the IC card can be significantly reduced.

That is, the greater part of the time required for issuance of the IC card is communication processing time required for sending instructions to the IC card, and if the communication time can be reduced, the time required for issuance of the IC card can be drastically reduced.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A portable electronic medium in which application data is stored in a nonvolatile memory based on a plurality of instructions supplied from a host device by serial communication and which performs processes by use of the stored application, comprising:
storage means for previously storing application data which is obtained by simulation based on a plurality of instructions, and which is to be stored in the nonvolatile memory, in the nonvolatile memory by use of the host device.

2. A portable electronic medium according to claim 1, wherein the application data stored in said storage means is bitmap data.

3. A portable electronic medium according to claim 1, wherein the application data stored in said storage means is collectively supplied according to one instruction.

4. A portable electronic medium according to claim 1, in which the application data stored in said storage means is supplied in a compressed form and which further comprises decompression means for decompressing the supplied application data.

5. A portable electronic medium according to claim 4, further comprising a volatile memory which stores a program according to which the compressed application data is decompressed by said decompression means and which is supplied from the host device at the start time of issuance.

6. A portable electronic medium issuing system comprising:
a host device, and
a portable electronic medium which is coupled with said host device by serial communication and includes a nonvolatile memory used to store files and file control information,
wherein said host device includes first creation means for creating a plurality of instruction messages for issuance of said portable electronic medium, second creation means for creating files and file control information obtained by simulation based on a plurality of instruction messages created by said first creation means and to be stored in a nonvolatile memory, and first transmission means for transmitting the files and file control information created by said second creation means and stored in the nonvolatile memory to said portable electronic medium by use of one message; and said portable electronic medium has storage means for storing files and file control information obtained by simulation based on a plurality of instructions supplied from said host device and stored in the nonvolatile memory.

7. A portable electronic medium issuing system according to claim 6, wherein the files and file control information stored in said storage means are bitmap data.

8. A portable electronic medium issuing system according to claim 6, wherein the files and file control information stored in said storage means are collectively supplied according to one instruction.

9. A portable electronic medium issuing system according to claim 6, wherein transmission means of said host device includes processing means for compressing and transmitting to-be-transmitted files and file control information, and said portable electronic medium includes decompression means for decompressing the compressed and transmitted files and file control information.

10. A portable electronic medium issuing system according to claim 9, wherein said host device includes transmission means for transmitting a program which decompresses the compressed and transmitted files and file control information to said portable electronic medium and said portable electronic medium includes a volatile memory which stores a program to decompress the compressed files and file control information supplied from said host device.

11. A method for issuing a portable electronic medium which includes a nonvolatile memory used to store files and file control information and which is to be coupled with a host device by serial communication, comprising:
creating a plurality of instruction messages for issuance of a portable electronic medium,
creating files and file control information obtained by simulation based on a plurality of created instruction messages and stored in a nonvolatile memory,
transmitting the created files and file control information stored in the nonvolatile memory to the portable electronic medium by use of one message, and
storing the transmitted files and file control information obtained by simulation based on the plurality of instructions, and stored in the nonvolatile memory.

12. A portable electronic medium issuing method according to claim 11, wherein the files and file control information stored in the storage means are bitmap data.

13. A portable electronic medium issuing method according to claim 11, wherein the files and file control information stored in the storage means are collectively supplied according to one instruction.

14. A portable electronic medium issuing method according to claim 11, wherein transmission means of the host device includes processing means for compressing and transmitting to-be-transmitted files and file control information, and the portable electronic medium includes decompression means for decompressing the compressed and transmitted files and file control information.

15. A portable electronic medium issuing method according to claim 11, wherein the host device includes transmission means for transmitting a program which decompresses the compressed and transmitted files and file control information to the portable electronic medium and the portable electronic medium includes a volatile memory which stores a program to decompress the compressed files and file control information supplied from the host device.
